(19) United States
(12) Patent Application Publication
(10) Pub. No.: US 2005/0025139 A1
(43) Pub. Date: Feb. 3, 2005

(54) Method for accessing a command unit for a data network

(75) Inventors: Dieter Brueckner, Unterleiterbach (DE); Franz-Josef Goetz, Heideck (DE); Dieter Klotz, Fuerth (DE); Karl-Heinz Krause, Nuernberg (DE); Juergen Schimmer, Nuernberg (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/809,446

(22) Filed: Mar. 26, 2004

Related U.S. Application Data
(63) Continuation of application No. PCT/DE02/03444, filed on Sep. 13, 2002.

(30) Foreign Application Priority Data
Sep. 26, 2001 (DE) 10147411.3
Aug. 14, 2002 (DE) 10237350.7

(51) Int. Cl. H04L 12/50; H04Q 11/00

(52) U.S. Cl. 370/362

(57) ABSTRACT

A method and a subscriber (100) of a data network (102) including a command unit (116) for accessing the data network (102); an operating assembly for operating a plurality of applications (104, 106, 108, . . . ) that access a data bus (110) of the subscriber (100); a first writer for a first one of the applications to write at least one command structure (118) into an address space of a memory of the subscriber (100) via the data bus (110); a second writer for the first application to write a pointer (124) to the address space into an input register (126) of the command unit (116) via the data bus (110); an enabling assembly for enabling the command unit (116) to access the address space via the data bus (110) and to process the command structure (118); and a third writer for writing the pointer (124) into an output register (136, 130) that is assigned to the first application, once the subscriber (100) has processed the command structure (118).

This is a Continuation of International Application PCT/DE02/03444, with an international filing date of Sep. 13, 2002, which was published under PCT Article 21(2) in German, and the disclosure of which is incorporated into this application by reference.

### FIELD OF AND BACKGROUND OF THE INVENTION

The invention relates to a method for accessing a command unit for a data network, in particular a real-time Ethernet. The invention further relates to a computer program product, a subscriber having such a command unit, and a communication system.

A synchronous, clocked communication system with equidistance properties is defined as a system with at least two subscribers that are interconnected via a data network so as to mutually exchange or transmit data. The data is exchanged cyclically in equidistant communication cycles, which are defined by the communication clock of the system. Subscribers are, for example, central automation devices; programming, configuration or control devices; peripherals, such as input/output modules, drives, actuators, sensors, stored-program controllers (SPCs); or other control units, computers or machines that exchange electronic data with other machines and, in particular, process data of other machines. Subscribers are also referred to as network nodes or, simply, nodes. Control units are defined as closed loop or open loop control units of any type as well as, for example, switches and/or switch controllers. The data networks are, for example, bus systems, e.g., field bus, Profibus, Ethernet, Industrial Ethernet, FireWire and PC-internal bus systems (PCI), etc., and, in particular, Isochronous Real-time Ethernet.

Data networks enable communication among a plurality of subscribers through networking, i.e., through connecting the individual subscribers with each other. “Communication” in this context means transmission of data between the subscribers. The data to be transmitted are sent as data messages, i.e., the data are bundled into a plurality of packets and are transmitted, in this form, to the respective recipient via the data network. These packets are also referred to as data packets. The term “transmission of data” or “data transmission” as used hereinafter is completely synonymous with the aforementioned transmission of data messages or data packets.

In distributed automation systems, e.g., in the field of drive technology, certain data must arrive at certain subscribers at certain times and be processed by the recipients. Therein, the data are referred to as real-time critical data or real-time critical data traffic because a delayed arrival of the data at the destination leads to undesirable results at the subscriber. This is in contrast to non-real-time critical data communication, for example Internet-based or intranet-based data communication. According to the IEC 61491, EN61491 SERCOS interface—Short Technical Description (http://www.sercos.de/pdf/sercos_kurzbeschreibung_de_{—}0202.pdf), successful real-time critical data traffic of the above-mentioned type is ensured in distributed automation systems.

Today, automation components (e.g., controls, drives, etc.) generally have an interface to a cyclically clocked communication system. One operation level of the automation component (fast cycle) (e.g., position control in a control unit or speed and torque control of a drive) is synchronized to the communication cycle. Thereby, the communication clock is determined. In addition, other, low-performance algorithms (slow cycle) (e.g., temperature controls) of the automation component can communicate with other components (e.g., binary switches for fans, pumps, etc.) only via this communication clock, although a slower cycle would be sufficient. Using only one communication clock for transmitting all information within the system places high demands on the bandwidth of the transmission path.

When a command unit is operated to access a data network (command interface) in a multi-master system, several applications can access the command unit simultaneously or consecutively, but, in any case, in an uncoordinated manner. This requires coordination of the individual applications' access to the command interface so as to ensure the transfer and processing of the commands at the command interface. To implement the applications, one or more processors (masters) of the subscriber may be provided.

Conventionally, the coordination of the applications' access is realized on the software level (driver) in that the applications are blocked by means of interrupt blocks for the duration of the application processing. On the hardware level, bus locking is used to prevent further access to the command interface. As a result, the software is also stopped for the duration of the processing. This has the following drawbacks:
Even if an application does not want to access the command interface, the software processing is interrupted because of the bus locking mechanisms; and
Due to the interrupt block, an interrupt event cannot be immediately processed for the duration of the command processing, and the interrupt routine is executed with a delay. The longest interrupt blocking time determines the interrupt latency of the system.

### OBJECTS OF THE INVENTION

It is one object of the invention to provide an improved method for accessing a command unit for a data network. It is a further object of the invention to provide an improved computer program enabling an application to access such a command unit. It is yet a further object of the invention to provide a subscriber for a communication system.

### SUMMARY OF THE INVENTION

In accordance with one formulation of the invention, these and other objects are achieved by a method for accessing a command unit for a data network, in which a plurality of applications is operated in a subscriber of the data network such that the applications access a data bus of the subscriber. A first one of the applications writes at least one command structure into an address space of a memory of the subscriber via the data bus. In addition, the first application writes a pointer to the address space into an input register of the command unit via the data bus. The command unit accesses the address space via the data bus and processes the command structure. After the subscriber has processed the command structure, the pointer is written into an output register that is assigned to the first application.

According to the invention, a command is not directly transferred to the command unit. Instead, a command is indirectly transferred in that a pointer to the address space of the command structure in the subscriber's memory is transferred into the input register of the command unit. This has the particular advantage that the transfer of the command to the command unit is executed as an “atomic” write access to the input register, which requires, for example, only one bus cycle.

According to a preferred embodiment of the invention, the command unit executes certain basic operations via the data network. The different applications use the command unit via a common interface. Therein, all applications are treated equally. An arbiter unit controls the access to an internal data bus of the subscriber for the applications' access to the command unit.

It is particularly advantageous that, because of the “atomic” write access to the input register of the command unit, no bus-lock mechanisms or interrupt-blocks are required. According to the invention, a command structure is first stored in the subscriber's memory, particularly in the communication memory, before this command structure is written into the input register by writing a pointer to the address space of the command structure in the memory. Both the processor and the command unit can access the communication memory.

The command unit then accesses the command structure and processes it. Compared to the direct transfer of the command parameters to the command unit, this has the advantage that command structures of any length, e.g., more than 32 bits, can be processed. In addition, the time for executing a command structure is not limited and different amounts of information can be returned.

A further advantage is that several applications can give commands, which do not necessarily have to be coordinated. Moreover, several, including identical, commands can be written into the input register, one directly after the other. There is no need to wait until each individual command has been executed.

According to another preferred embodiment of the invention, the command unit acknowledges commands accepted via the input register by entering the acknowledgment in an acknowledge field in the command structure in the subscriber's memory.

According to another preferred embodiment of the invention, there are no locking or blocking demands on the data bus, i.e., the bus is never locked beyond a single read or write operation. Nor is there an upper limit regarding the amount of information that is transferred between the applications and the command unit. No coordination, such as interrupt blocks between the calling applications, is necessary.

According to another preferred embodiment of the invention, all commands dispatched by the applications are transferred to the input register (command interface) in one write cycle so as to avoid bus lock times. Merely a pointer (address) to a memory area, which contains the command structure that was previously stored in the memory by the application, is transferred to the command interface. This prevents multiple write accesses to the command interface, which would otherwise be required for commands with several operands.

From the address space in the memory, the command interface then reads the command data from a defined command structure, interprets the data and forwards them to the respective execution unit for processing.

The active data bus subscribers, i.e., the active applications, can have independent write access to the command interface. As a result, multi tasking through non-coordinated (mixed) access by the different applications to the command interface is also supported. Preferably, to prevent the individual tasks of an application from being mutually blocked by interrupt blocks, mechanisms are implemented in the command interface, which optionally allow access to the interface by all applications in different sequences and at different times.

Preferably, the applications detect whether their pointers to a command structure that was written to the command interface have been accepted. If the read and the written address are identical, the command was accepted at the command interface. If they differ, there may be one of two reasons for this:
The command was not accepted because acceptance or transfer of an earlier command had not yet been completed.
The command was already accepted or transferred, but another command was already accepted or transferred between the write and read operation. This situation can occur with an application (kernel with preemptive multitasking, if this not managed by the operating system) and with systems that have a plurality of physical subscribers.

Thus, preferably, the hardware supports two mechanisms, both of which must be used by the software for unique identification:
Readback of the previously written data (address to command structure) from the command interface. Therein, it is detected whether the data of an application have been accepted at the command interface. If yes, the command is executed via the command interface; if no, the data of a second application had previously been entered in the interface but had not yet been entered in the command list by the hardware, so that the first application's command could not be accepted.
Acknowledgment of the accepted data. If the following actions are executed at the command interface between writing and readback of the address, e.g.:
   acceptance of the command by the command interface,
   acknowledgement of the acceptance by the command interface via an “acknowledge” field in the command structure,
   writing of new address data into the command interface by a second subscriber,
      then the written data and the readback data no longer match. The acceptance or transfer of a command can now be uniquely identified merely based on the acknowledge field of the command structure.

To exclude a critical race, the acknowledge field is preferably not set until just before the command interface is writable again. As a rule, the acceptance or transfer of a command is completed when the command structure is entered in a command list, i.e., the acceptance or transfer occurs rapidly. An optimization for the shortest possible and guaranteed acceptance or transfer has priority, such that, if there is a new write access to the command interface, unnecessary waiting times in the processing of the software are avoided.

According to another preferred embodiment of the invention, a command or command sequences of the applications are transferred to the command unit via a jointly used input register (command register).

The address (pointer) to a command structure is stored in the command register. The structure itself contains all the data necessary to process the command. To avoid blocking the command register for the entire command processing time if the command processing takes a long time, the transferred command structure is entered into a command list. For this purpose, the command structure contains a “next” pointer, which is used to link structures that have not yet been processed. The “next” pointer contains the address of the next command structure that has not yet been processed. This linkage provides intermediate storage of the command structures in the command list. This makes it possible to decouple the processing of the commands from the command transfer.

If a subscriber performs a write access to the register, the acceptance or transfer of further data at the command register is prevented until the transferred command has been entered in the command list. A new write access to the command register is accepted only after the command interface has acknowledged the acceptance of the command by setting the respective “acknowledge” field.

After the commands transferred via the command register have been processed, the associated command structures are returned to the subscriber. For each application, there is a separate return register, hereinafter also referred to as output register, through which the command structures are transferred. To avoid having to provide real-time pickup by the subscribers of the command structures at the return register, the processed structures are entered in separate subscriber-specific return lists. The return of each processed structure is announced to the respective subscriber. Therein, the linked command structures are returned via the return register.

According to another preferred embodiment of the invention, an application transfers a command structure to the command interface by a write access to the command register.

As a result of the write operation to the command register, no data of subsequent write accesses are accepted until the command interface has entered the transferred structure in the common command list and has acknowledged acceptance or transfer in the acknowledge field of the structure. Read accesses to the command register continue to be allowed, however. To check whether the just written value has actually been entered in the command register, the data of the register are read back. If the write and the read data match, the write cycle to the command register has been executed.

The written and the read data can differ for one of two reasons:
During the time interval between the write and the read cycle of an application 1, the command structure entered in the command register was already accepted or transferred in the command list and the acknowledgment was set in the acknowledge field of the structure. Thereafter, the writing of new data to the command register was enabled. Even before the application 1 executed its read cycle, the application 2 was able to execute a write access to the command register.
Before an application 1 was able to write to the command register, the application 2 already executed a write access. This prevents the entry of the subsequent address data of the application 1.

Preferably, if the write and the read data differ, the application must analyze the acknowledge field of the command structure. If the acknowledgment has been set in the acknowledge field of the structure, then the command structure has been accepted or transferred and entered in the command list. Any non-acknowledged acceptance or transfer of the structure results in a cyclic write access to the command register (polling).

Furthermore, it is a particular advantage that the disclosed methods can be used in automation systems, particularly in packaging machines, presses, plastic extruders, textile machines, printing machines, machine tools, robots, handling systems, wood processing machines, glass processing machines, ceramic processing machines and lifting equipment.

A further advantage is that the invention can be used for communication applications as well as other applications, e.g., command interfaces of other intelligent subsystems, in particular graphic systems.

### BRIEF DESCRIPTION OF THE DRAWINGS

Preferred embodiments of the invention will now be described in greater detail with reference to the drawings, in which:

FIG. 1 shows a block diagram of an exemplary embodiment of a data network subscriber according to the invention;

FIG. 2 shows a schematic of an exemplary embodiment of a command interface;

FIG. 3 shows an exemplary embodiment of linked command structures in the subscriber's memory; and

FIG. 4 shows a flow diagram of an exemplary embodiment of the method according to the invention.

### DETAILED DESCRIPTION OF THE PREFERRED EMBODIMENTS

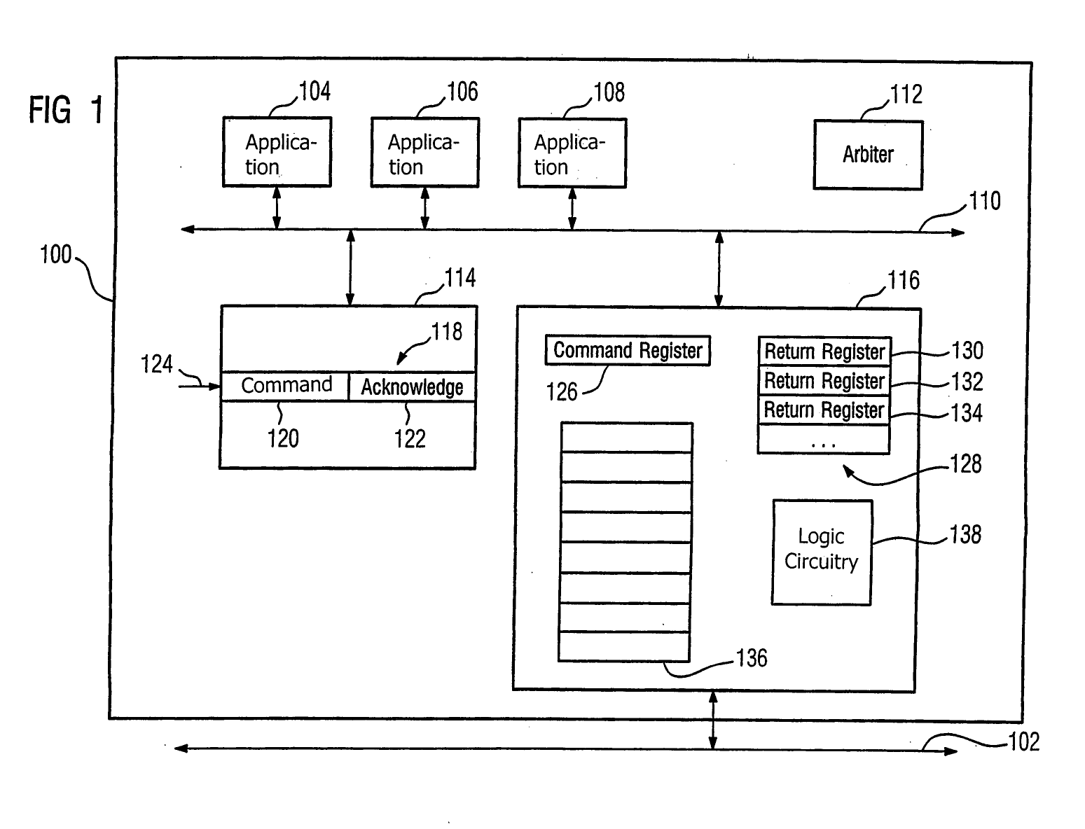

FIG. 1 shows a subscriber 100 of a data network 102. This data network 102 is, for example, a Realtime Ethernet employed in automation technology applications. A plurality of subscribers, which, in principle, are constructed like the subscriber 100, are typically connected to the data network 102. Thereby, a communication system is constructed.

The subscriber 100 has a plurality of applications 104, 106, 108, . . . , which access a data bus 110 of the subscriber 100. An arbiter 112 controls the access of the individual applications 104, 106, 108, . . . to the data bus 110.

Further, the subscriber 100 has a memory 114 and a command unit 116. The memory 114 and the command unit 116 are also coupled to the data bus 110.

Each of the applications 104, 106, 108 write a command structure 118 into the memory 114 via the data bus 110. In the exemplary embodiment shown in FIG. 1, the command structure 118 includes a command 120 executable by the command unit 116 and an acknowledge field 122. The command structure 118 is stored in an address space of the memory 114 to which a pointer 124 points.

The command unit 116 is coupled to both the data bus 110 and the data network 102. The command unit 116 executes various basic operations related to the data network 102 with respect to the applications 104, 106, 108, . . . The command unit 116 includes an interface for the applications 104, 106, 108, . . . , which has a command register 126 and a plurality of return registers 128.

The command register 126 is used as an input register for storing pointers 124. Each of the applications 104, 106, 108, . . . can access the command register 126 via the data bus 110. Each of the return registers 128, however, is assigned to a specific application. For example, the return register 130 is assigned to the application 104, the return register 132 is assigned to the application 106, and the return register 134 is assigned to the application 108, etc.

The command unit 116 further includes a command list 136, which is also referred to as a stack. The command list 136 contains the commands that have been accepted and that are to be processed by the command unit 116.

In addition, the command unit 116 has a logic circuit 138 for processing the commands.

In operation, one of the applications of the subscriber 100, e.g., the application 104, accesses the memory 114 via the data bus 110 to store the command structure 118 therein. Thereafter, the application 104 performs a write access to the command register 126 via the data bus 110 so as to write the pointer 124 to the command structure 118 into the command register 126. The command unit 116 then transfers the command structure 118 from the memory 114 into the command list 136 and acknowledges the transfer by a respective entry in the acknowledge field 122 of the command structure 118.

After the command structure 118 has been processed, the command unit 116 writes the pointer 124 into a return register 130 that is associated with the application 104. The application 104 can query the return register 130 by means of a read access via the data bus 110 so as to check whether the command structure 118 has already been processed.

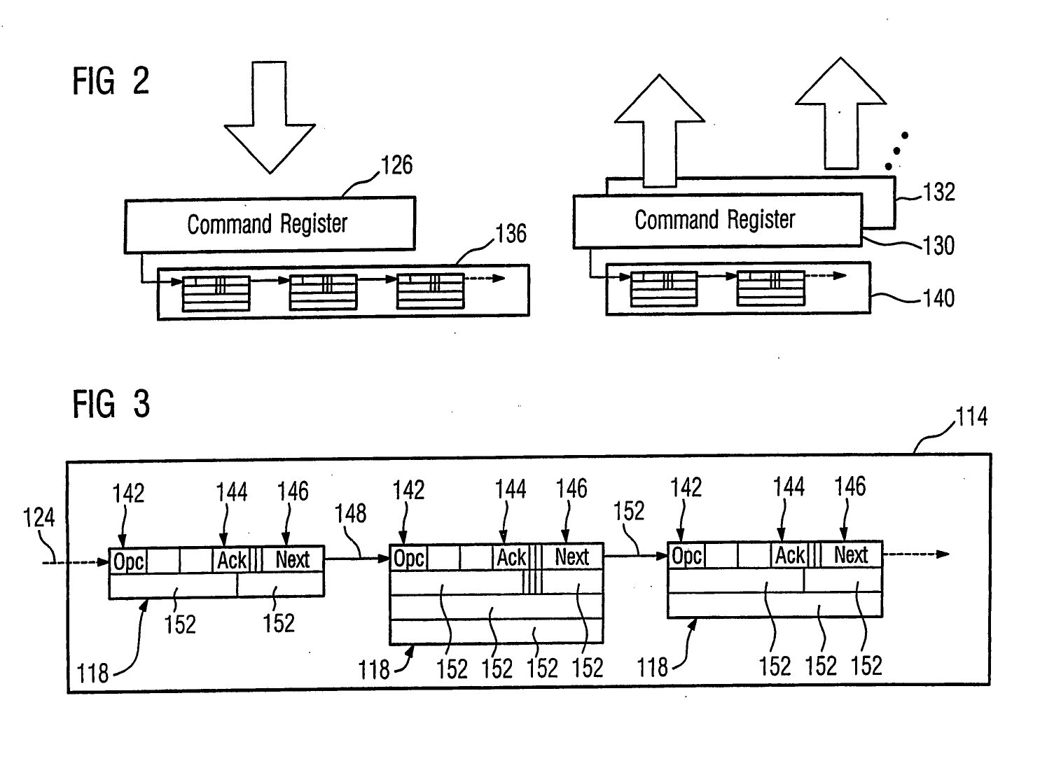

FIG. 2 shows an exemplary embodiment of the command interface depicted in FIG. 1.

Therein, the different applications 104, 106, 108, . . . can write into the command register 126 in an uncoordinated manner. The accepted or transferred command structures 118 make up the command list 136.

Each of the return registers 130, 132, 134, . . . is assigned to a return list 140. The return list 140 is assigned to the return register 130, which, in turn, is assigned to the application 104. By means of the return list 140, the output of the pointers 124 is buffered.

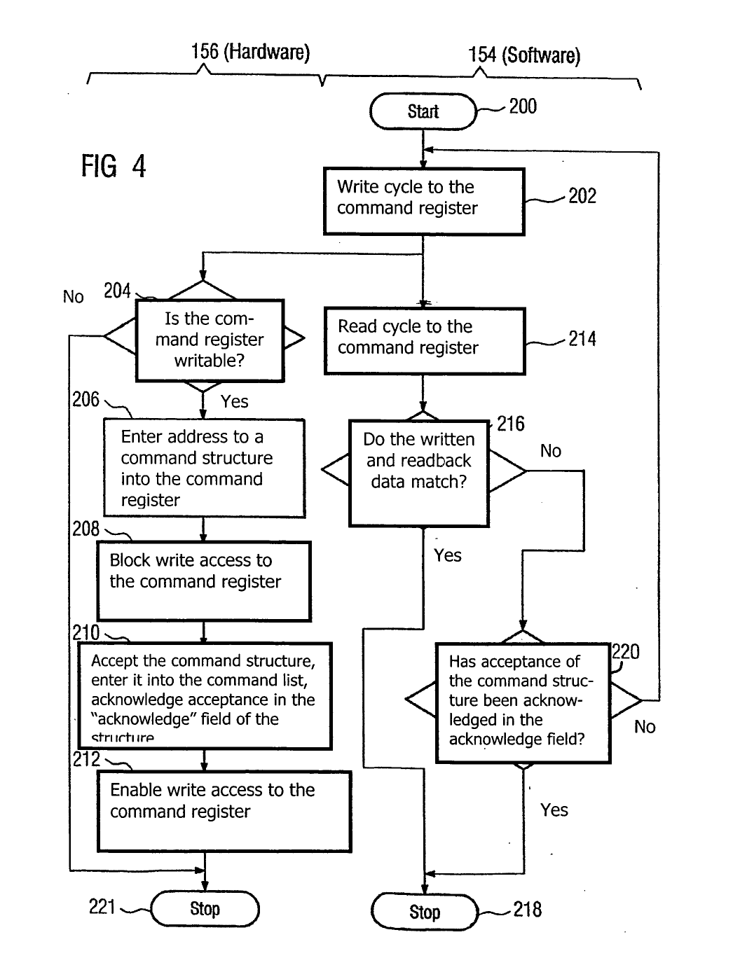

FIG. 3 shows an exemplary embodiment of a linked command structure in the memory 114. In this exemplary embodiment, the command structure 118 has a field 142 for storing one or more commands 120 (cf. FIG. 1); a field 144 for storing an acknowledgment in accordance with the acknowledge field 122 of FIG. 1; and a field 146 for storing a pointer 148 to a further command structure 118, which is, in principle, constructed in the same manner. The further command structure 118 has a pointer 150 to another command structure 118, etc. The last command structure 118 of the chain has no further pointer. Thereby, the last member of the linked command structure is identified.

Furthermore, the command structures 118 have fields 152 for storing parameters, user data or operands for executing the corresponding command 120.

In this exemplary embodiment, if the pointer 124 is transferred to the command register 126 (cf. FIG. 1) and if the command unit 116 acknowledges the transfer, the command unit 116 processes the entire chain of command structures 118. In other words, with a single “atomic” write access to the command register 126, e.g., within one bus cycle, an application can trigger the processing of a complex sequence of commands by the command unit 116.

FIG. 4 is a flow diagram of a method for operating the system depicted in FIG. 1. This method is subdivided into a software process 154 and a hardware process 156. Once the software process 154 is started up in step 200, the application to which the software process 154 belongs, e.g., the application 104 shown in FIG. 1, performs a write access to the command register in one bus cycle. This occurs in step 202. In the write cycle, the application 104 transfers the pointer 124 to the command structure 118, and/or to a chain of command structures 118. This starts the hardware process 156.

Step 204 of the hardware process 156 checks whether the command register is writable. If not, the sequence ends in step 206. In this case, the application has to restart the software process 154 with step 200.

If the command register is writable, however, then the pointer 124 transferred by the application 104 is entered into the command register. This occurs in step 206. The write access to the command register is then blocked in step 208, such that other applications cannot overwrite the pointer that is located in the register.

In step 210, the command structure, or the linked command structure, is accepted or transferred, i.e., the commands to be processed are entered into the command list and the acceptance or transfer is acknowledged in the acknowledge field of the command structure.

Write access to the command register is then enabled again in step 212, and the sequence of the hardware process 156 ends with step 206.

Following the write cycle in step 202, a read cycle to the command register is executed in step 214 of the software process 154. In step 216, the process checks whether the data previously written into the command register in step 202, i.e., the pointer 124, is still in the command register.

If yes, then this means that the command structure has been accepted or transferred in step 210, such that the software process ends with step 218. If no, then this can mean that acceptance or transfer took place and another application has already written a different pointer into the command register. Alternatively, this can mean that acceptance or transfer did not take place by the hardware process 156. In this case, the acknowledge field in the command structure is checked in step 220. If an acknowledgement has been entered in that field, then, in turn, the software process 154 can be terminated with step 218. If this is not the case, the sequence control has to return to step 202.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. A method for accessing a command unit for a data network, comprising:
operating a plurality of applications in a subscriber of the data network such that the applications access a data bus of the subscriber;
by a first one of the applications, writing at least one command structure into an address space of a memory of the subscriber via the data bus;
by the first one of the applications, writing a pointer to the address space into an input register of the command unit via the data bus;
by the command unit, accessing the address space via the data bus and processing the command structure; and
after the subscriber has processed the command structure, writing the pointer into an output register that is assigned to the first one of the applications.

2. The method as claimed in claim 1, further comprising controlling access to the data bus by an arbiter unit, such that access is allowed for a predefined number of bus cycles and such that the predefined number of bus cycles is sufficient for writing the pointer into the input register.

3. The method as claimed in claim 1, wherein the command structure includes an acknowledge field, and wherein the method further comprises:
after writing the pointer by the subscriber, blocking the input register;
by the subscriber, writing an acknowledgment into the acknowledge field;
after the acknowledgment, enabling the input register by the subscriber.

4. The method as claimed in claim 3, further comprising:
after writing the pointer, reading the input register by the first one of the applications;
by the first one of the applications, checking whether the input register includes the pointer;
if the input register does not include the pointer, checking whether the acknowledgement has been stored in the acknowledge field.

5. The method as claimed in claim 1, wherein the command structure includes executable commands and user data.

6. The method as claimed in claim 1,
wherein the first one of the applications writes a plurality of interlinked command structures into the memory; and
wherein the pointer points to the address space of a first one of the command structures of the plurality of interlinked command structures.

7. A computer program product for an application of a subscriber of a data network, wherein the application accesses a data bus for a plurality of applications of the subscriber, wherein the subscriber has an input register and an output register assigned to the application, the computer program product comprising:
a computer-readable medium; and
computer-readable instructions on the computer-readable medium enabling a processor to perform the following operations:
writing a command structure into an address space of a memory of the subscriber via the data bus;
writing a pointer to the address space into the input register of the command unit via the data bus; and
reading the input register to check whether the command unit has acknowledged the command structure.

8. The computer program product as claimed in claim 7, wherein the computer program product comprises a digital storage medium.

9. The computer program product as claimed in claim 7, further comprising checking an acknowledge field in the command structure if the pointer is no longer located in the input register when the input register is read.

10. The computer program product as claimed in claim 7,
wherein a plurality of interlinked command structures is written into the memory of the subscriber; and
wherein the pointer points to the address space of a first command structure of the plurality of interlinked command structures.

11. A computer program product as claimed in claim 7, wherein the output register assigned to the application is read to check whether the command unit has processed the command structure.

12. A subscriber of a data network, comprising:
a command unit configured to access the data network, the command unit having an input register;
an operating assembly configured to operate a plurality of applications such that the applications access a data bus of the subscriber;
a memory having an address space;
a first writer configured to write at least one command structure into the address space by a first one of the applications via the data bus;
a second writer configured to write a pointer to the address space into the input register by the first one of the applications via the data bus;
an access assembly for the command unit configured to access the address space via the data bus and configured to process the command structure; and
a third writer configured to write the pointer into an output register that is assigned to the first one of the applications after the subscriber has processed the command structure.

13. The subscriber as claimed in claim 12, further comprising:
an arbiter unit configured to control access to the data bus, wherein the access is allowed for a predefined number of bus cycles, and wherein the predefined number of bus cycles is sufficient for writing the pointer into the input register.

14. The subscriber as claimed in claim 12, wherein the command structure has an acknowledge field, the subscriber further comprising:
a blocker configured to block the input register after writing the pointer by the subscriber;
a fourth writer configured to write an acknowledgment into the acknowledge field by the subscriber; and
an enabling assembly configured to enable the input register by the subscriber after the acknowledgment.

15. The subscriber as claimed in claim 14, further comprising:
a reader configured to read the input register by the first application after writing the pointer; and
a checker configured to check, by using the first one of the applications, whether the input register includes the pointer and, if the input register does not include the pointer, configured to check whether an acknowledgment has been stored in the acknowledge field.

16. The subscriber as claimed in claim 12, wherein the command structure includes executable commands and user data.

17. The subscriber as claimed in claim 12, further comprising a plurality of interlinked command structures in the memory, wherein the pointer is configured to point to the address space of a first one of the plurality of interlinked command structures.

18. A communication system, comprising:
a data network; and
a plurality of subscribers, each subscriber comprising:
a command unit configured to access the data network, the command unit having an input register;
an operating assembly configured to operate a plurality of applications such that the applications access a data bus of the subscriber;
a memory having an address space;
a first writer configured to write at least one command structure into the address space by a first one of the applications via the data bus;
a second writer configured to write a pointer to the address space into the input register by the first one of the applications via the data bus;
an access assembly for the command unit configured to access the address space via the data bus and configured to process the command structure; and
a third writer configured to write the pointer into an output register that is assigned to the first one of the applications after the subscriber has processed the command structure.
